(19) United States
(12) Patent Application Publication
(10) Pub. No.: US 2005/0267757 A1
(43) Pub. Date: Dec. 1, 2005

(54) Handling of acronyms and digits in a speech recognition and text-to-speech engine

(75) Inventors: Juha Iso-Sipila, Tampere (FI); Janne Suontausta, Tampere (FI); Jilei Tian, Tampere (FI)

Correspondence Address: FOLEY & LARDNER, 321 NORTH CLARK STREET, SUITE 2800, CHICAGO, IL, 60610-4764, US

(73) Assignee: Nokia Corporation

(21) Appl. No.: 10/856,207

(22) Filed: May 27, 2004

(51) Int. Cl. G10L 13/00

(52) U.S. Cl. 704/260

(57) ABSTRACT

A method is disclosed for the detection of acronyms and digits and for finding the pronunciations for them. The method can be incorporated as part of an Automatic Speech Recognition (ASR) and Text-to-Speech (TTS) system. Moreover, the method can be part of Multi-Lingual Automatic Speech Recognition (ML-ASR) and TTS systems. The method of handling of acronyms in a speech recognition and text-to-speech system can include detecting an acronym from text, identifying a language of the text based on non-acronym words in the text, and utilizing the identified language in acronym pronunciation generation to generate a pronunciation for the detected acronym.

### BACKGROUND OF THE INVENTION

1. Field of the Invention

The present invention relates generally to speech recognition and text-to-speech (TTS) synthesis technology in telecommunication systems. More particularly, the present invention relates to handling of acronyms and digits in a multi-lingual speech recognition and text-to-speech engine in telecommunication systems.

2. Description of the Related Art

Text to speech (TTS) converters have been used to improve access to electronically stored information. Conventional TTS converters can produce intelligible speech only from text that conforms to the spelling and grammatical conventions of a language. For example, most converters cannot read typical electronic mail (e-mail) messages intelligibly. Unlike carefully edited text, e-mail messages, phone directory entries, and calendar appointments (for example) frequently contain sloppy, misspelled text with random use of case, spacing, fonts, punctuation, emotion indicators and a preponderance of industry-specific abbreviations and acronyms. In order for text to speech conversion to be useful for such applications, it must implement flexible, sophisticated rules for intelligent interpretation of even the most ill-formed text messages.

In a speaker-independent name dialing (SIND) system, an electronic phone directory or phonebook contents can be used by voice without user training, or voice tagging. Thus, the whole phonebook contents are available by voice immediately. The text contents of an electronic phonebook associated with a communication device, such as a cell phone, may not be known beforehand. Furthermore, different users may have various schemes to mark/indicate certain things in phone directories, for example. Many people use acronyms, digits or special characters in the phonebook to make the phonebook entries shorter or remove ambiguity in the entries. If all the users stored the names in a telephone directory manner, the work of the SIND engine would be a lot easier. Unfortunately, in practice this practice is not followed.

When the user inputs an acronym to the phonebook, he or she can pronounce it as it is spelled out letter by letter or as a word. In general, there is no easy solution to detect an acronym out of normal words, especially not in a multi-lingual system.

Conventional Automatic Speech Recognition (ASR) and Text-to-Speech (TTS) systems find the pronunciations for words using look-up tables. Vocabulary words and their pronunciations can be stored in look-up tables. Similarly, another look-up table can be constructed for the acronyms for finding their pronunciations.

The direct look-up table approach has several disadvantages. For a vocabulary that is composed of multi-lingual vocabulary items, the pronunciation of the acronym depends on the language. Currently, systems may be able to deal with text input that is composed of words. However, known systems cannot process acronyms and digits.

U.S. Pat. No. 5,634,084 to Malsheen et al. describes methods where an acronym, special word, or tag is expanded for a text-to-speech reader. The Malsheen patent describes the use of a special lookup table to generate a pronunciation. Like other look-up table solutions, however, the system described by the Malsheen patent cannot process multi-lingual vocabulary items.

Therefore, a method is needed to decide the language before the pronunciation of the acronym can be found. Also, it is desirable to separate the generation of the pronunciations of the regular words from the generation of the pronunciations of the acronyms. In addition, language dependent tables are needed for finding the pronunciations of the acronyms.

### SUMMARY OF THE INVENTION

In general, the invention relates to a method for the detection of acronyms and digits and for finding the pronunciations for them. The method can be incorporated as part of an Automatic Speech Recognition (ASR) and Text-to-Speech (TTS) system. Moreover, the method can be part of Multi-Lingual Automatic Speech Recognition (ML-ASR) and TTS systems.

An exemplary method for detecting acronyms and for finding their pronunciations in the Text-to-Phoneme (TTP) mapping can be part of voice user interface software. An exemplary ML-ASR engine or system can include automatic language identification (LID), pronunciation modeling, and multilingual acoustic modeling modules. The vocabulary items are given in textual form for the engine. First, based on the written representation of the vocabulary item, a LID module identifies the language. Once the language has been determined, an appropriate TTP modeling scheme is applied in order to obtain the phoneme sequence associated with the vocabulary item. Finally, the recognition model for each vocabulary item is constructed as a concatenation of multilingual acoustic models. Using these modules, the recognizer can automatically cope with multilingual vocabulary items without any assistance from the user.

The TTP module can provide phoneme sequences for the vocabulary items in both ASR as well as in TTS. The TTP module can deal with all kinds of textual input provided by the user. The text input may be composed of words, digits, or acronyms. The method can detect acronyms and find the pronunciations for words, acronyms, and digit sequences.

One exemplary embodiment relates to a method of handling of acronyms in a speech recognition and text-to-speech system. The method includes detecting an acronym from text, identifying a language of the text based on non-acronym words in the text, and utilizing the identified language in acronym pronunciation generation to generate a pronunciation for the detected acronym.

Another exemplary embodiment relates to a device that applies speech recognition and text-to-speech to acronyms. The device includes a language identifier module that identifies a language of text and vocabulary items from the text, a text to phoneme module that provides phoneme sequences for identified vocabulary items, and a processor that executes instructions to construct text to speech signals using the phoneme sequences from the text to phoneme module based on the identified language of the text.

Another exemplary embodiment relates to a system for applying speech recognition and text-to-speech with acronyms. The system includes a language identifier that identifies language of a text including a plurality of vocabulary items, a vocabulary manager that separates the vocabulary items into single words and detects acronyms in the vocabulary items, and a text-to-phoneme (TTP) module that generates pronunciations for the vocabulary items including pronunciations for acronyms and digit sequences.

Yet another exemplary embodiment relates to a computer program product including computer code to detect acronyms from text including acronyms and non-acronyms and mark the detected acronyms, identify a language of the text based on non-acronym words, and use the language in acronym pronunciation generation.

### BRIEF DESCRIPTION OF DRAWINGS

FIG. 1 is a flow diagram depicting operations performed in finding the pronunciation of an acronym.

FIG. 2 is a diagram depicting at least a portion of a multi-lingual automatic speech recognition system.

FIG. 3 is a flow diagram depicting exemplary operations in the generation of pronunciation for a vocabulary with acronyms and digits.

FIG. 4 is a general flow diagram of operations in a system that provides text to speech and automatic speech recognition for acronyms

### DETAILED DESCRIPTION OF EXEMPLARY EMBODIMENTS

Before describing the exemplary embodiments for generating the pronunciations of acronyms and digits, some definitions are presented. “Word” is a sequence of letters or characters separated by a white space character. “Nametag” is a sequence of words. “Acronym” is a sequence of capital letters separated by space from other words. Acronym is generated (usually) by taking the first letters of each word in the utterance and concatenating them after each other. For example, IBM stands for International Business Machines.

“Digit sequence” is a set of digits. It can be separated by space from other words or it can be embedded (in the beginning, middle or at the end) into a sequence of letters. “Abbreviation” is a sequence of letters that is followed by a dot. Also, special Latin derived abbreviations exist: E.g. stands for “for example,” i.e. stands for “that is,” jr. stands for “junior.” “Vocabulary entry” is composed of words, acronyms, and digit sequences.

The vocabulary in the speech recognition system described herein is composed of entries, a single entry is composed of words, acronyms, and digit sequences. An entry can be a mix of capital and lower case characters, digits, and other symbols and it contains at least one character. One of the simplest entries can look like “Timo Makinen” containing the first and the last name of a person. Another entry may look like “Matti Virtanen GSM”. In this example, the last entity in the entry is an acronym since it is all capitals. When the user is inputting the entries with the mixed capital and lower case characters, it is possible to distinguish between the acronyms and the rest of the words. Therefore, regular words preferably contain lower case characters. If the nametag is written in all the capital letters, it is assumed that it does not contain any acronym.

The multi-lingual ASR and TTS engine described herein covers Asian languages like Chinese or Korean. In such languages, words are represented by symbols and there may not be a need to handle acronyms but there may be a need to handle digit sequences.

Yet another example of an entry is “Bill W. Smith”. In the entry there is an entity that is composed of a single letter and a dot symbol. A single letter with or without a dot is assumed to be an acronym.

In principle, some acronyms like “SUN” (Stanford University Network) can be pronounced as words. Some other acronyms, like GSM cannot be pronounced as words. Instead, they are spelled letter by letter. For purposes of description, it is assumed that all the acronyms are spelled letter by letter. The entries may also contain digit sequences like “123”. The digit sequences are treated like acronyms, and they are isolated from the rest of the entry and processed separately. The digit sequences may be pronounced as “one hundred and twenty three” or they may be spelled out digit by digit as “one, two, three”. It is assumed that the digit sequences are spelled digit by digit. Such assumptions are illustrative only.

In addition to character symbols and digits, the entries may contain other symbols that are not pronounced at all (like the dot in “Bill W. Smith”). The non-character and non-digit symbols are removed from the entries prior to the generation of the pronunciations.

For purposes of describing exemplary embodiments, the following assumptions are made.
An acronym is written in capital letters
Acronyms are spelled letter by letter
The spelling of the individual letters are stored in language specific look-up tables for the set of languages of interest
Digit sequences are spelled out digit by digit
The spelling of the individual digits are stored in language specific look-up tables for the set of languages of interest

The exemplary embodiments detect acronyms in the entries of the vocabulary and generate the pronunciations for the acronyms in a multi-lingual speech recognition engine. The approach for generating the pronunciations for the acronyms utilizes the algorithm for detecting the acronyms.

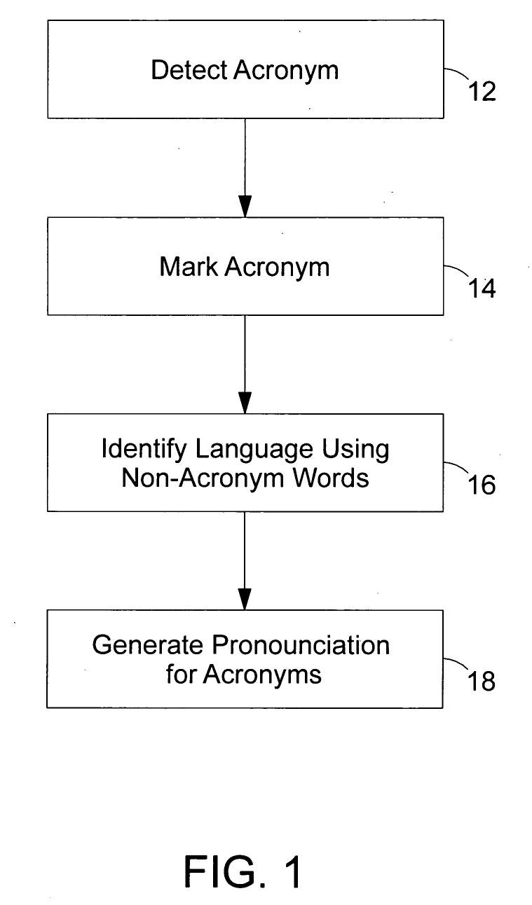

FIG. 1 illustrates a flow diagram of operations performed in finding the pronunciation of an acronym according to an exemplary embodiment. Additional, fewer, or different operations may be performed, depending on the embodiment.

In an operation 12, an acronym is detected. The acronym can be detected by identifying words with multiple capital letters. In an operation 14, the detected acronym is marked. For example, marking can include adding special markers (e.g., “<” and “>”) to detected acronyms and digits for further processing by a language identifier and a text-to-phoneme (TTP) module. For example, the phrase John GSM would be converted to john <GSM>.

If there is only one word in the nametag, it cannot be an acronym. If all the words are in capital letters, there are no acronyms since it is assumed that the user inputs acronyms with capital letters. If at least one word is all capital letters, all those words are set to be acronyms. Words with single letter, possibly followed by dot character, are considered to be acronyms, e.g., John J. Smith=>john <J> smith.

In an operation 16, the language of the text is identified. The language can be English, Spanish, Finnish, French, or any other language. The language is identified using non-acronym words in the text that can be compared to words contained in tables or by using other language discerning methods. In an operation 18, a pronunciation for the acronyms that were detected and marked is provided using the language identified in operation 16. The pronunciation can be extracted from language-dependent acronym or alphabet tables, for example.

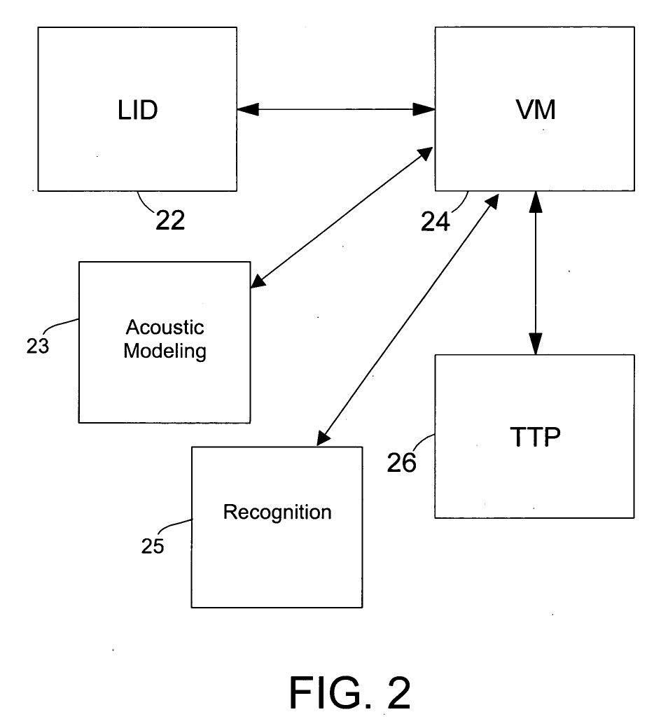

FIG. 2 illustrates a multi-lingual automatic speech recognition system including a language identifier (LID) module 22, a vocabulary management (VM) module 24, and a text-to-phoneme (TTP) module 26. The automatic speech recognition system also includes an acoustic modeling module 23 and a recognition module 25. The LID module 22 identifies the language of each vocabulary item based on its textual form.

In an exemplary embodiment, the generation of the pronunciations for acronyms requires the interaction between the LID module 22, the TTP module 26, and the vocabulary management (VM) module 24. The vocabulary management module 24 is a hub for the TTP module 26 and LID module 22, and it is used to store the results of the TTP module 26 and LID module 22. The processing of the TTP module 26 and LID module 22 assumes that the words are written in the lower case characters and the acronyms are written in the upper case characters. If any case conversions are needed, the TTP module 22 provides them for the global alphabet covering the target languages. The TTP module 22 automatically converts non-acronym words into lower case prior to the generation of the pronunciations. The acronyms are converted into upper case in the VM module 24 to match the predefined spelling pronunciation rules.

During the processing, the VM module 24 splits the entries in the vocabulary into single words. Since the VM module 24 has the full information about the entries in the vocabulary, it implements the logic for the detection of the acronyms. The detection algorithm is based on the detection of upper case words. Since the TTP module 26 stores the global alphabet of the target languages as well as the language dependent alphabet sets, the VM module 24 utilizes the TTP module 26 for finding the upper case words. Based on the detection logic, if a word in an entry is recognized as an acronym, the prefix “<” will be put in front of the acronym and the suffix “>” at the end of the acronym. This will enable the LID module 22 and the TTP module 26 to be able to distinguish between the regular words and the acronyms.

After the entry is broken into individual words and the acronyms have been isolated, the individual words in the entry are passed on to the LID module 22. The LID module 22 assigns a language identifier for the name tag based on the regular words in the entry. The LID module 22 ignores the acronym and digit sequences. The identified language identifier is attached to acronyms and digit sequences.

After the language identifiers have been assigned to the entries, the VM module 24 calls the TTP module 26 for generating the pronunciations for the entries. The TTP module 26 generates the pronunciations for the regular words with TTP methods, e.g., look-up tables, pronunciation rules, or neural networks (NNs). The pronunciations for the acronyms are extracted from the language dependent acronym/alphabet tables. The pronunciations for the digit sequences are constructed by concatenating the pronunciations of the individual digits. If there are symbols in the entry that are not characters or digits, they are ignored during the processing of the TTP algorithm.

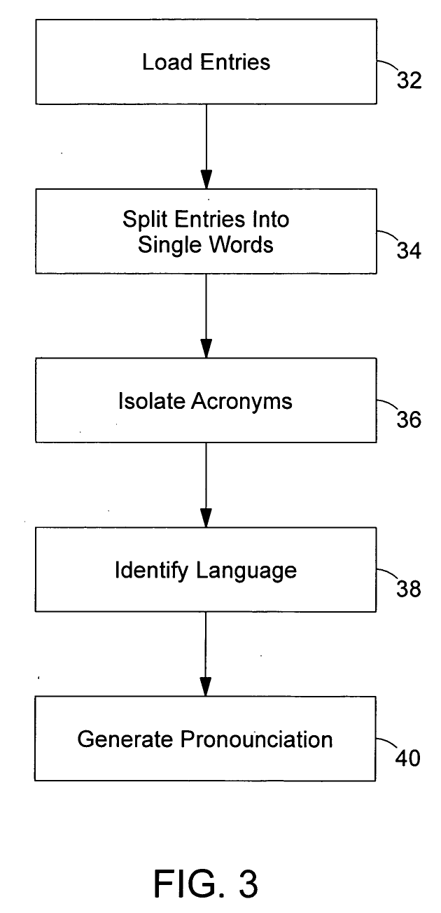

FIG. 3 illustrates the generation of pronunciations for vocabulary entries. In an operation 32, the VM module loads entries from a text. In an operation 34, the VM module splits the entries in the vocabulary into single words. This segmentation or separation can be done by finding spaces between text characters. In an operation 36, the VM module implements detection logic for isolating the acronyms and puts the prefix “<” and the suffix “>” for the acronyms. At least one embodiment has detection logic that utilizes the TTP module for detecting the upper case words as acronyms.

In an operation 38, the VM module passes the processed entries into the LID module that finds the language identifiers for the entries. The LID module ignores acronyms and digit strings. In an operation 40, the VM module passes the processed entries to the TTP module that generates the pronunciations. The TTP module applies the language dependent acronym/alphabet and digit tables for finding the pronunciations for the acronyms and digit sequences. For the rest of the words, non-acronym TTP methods are used. The unfamiliar characters and non-digit symbols are ignored.

Referring to FIGS. 2 and 3, the division of the computation between the modules is not essential, the computation may be redistributed for another module definitions. In these exemplary embodiments, the generation of pronunciations relies on language specific acronym and digit tables.

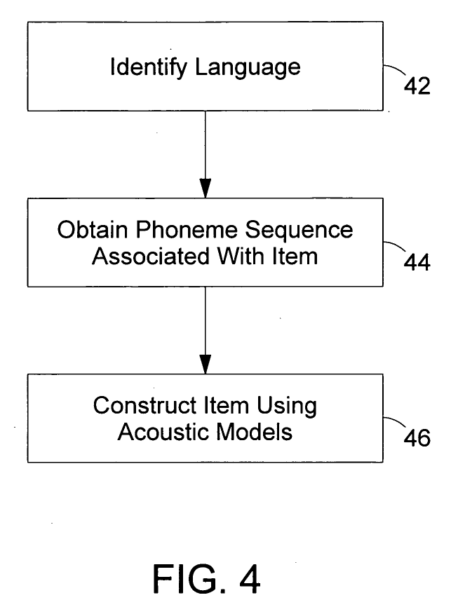

FIG. 4 illustrates a general flow diagram of operations in a system that provides text to speech and automatic speech recognition for acronyms according to an exemplary embodiment. Additional, fewer, or different operations may be performed, depending on the embodiment. In operations 42, 44, and 46, the system detects and marks the detected acronyms, identifies the language of the text based on non-acronym words, and uses the language in acronym pronunciation generation. The detecting of acronyms can be based on specific rules, such as acronyms use all capital letters or acronyms are words not found in a language-specific dictionary file or words with a special character tag (e.g., --, *, #). An acronym/alphabet pronunciation table is used for the generation of pronunciations for these special cases.

While several embodiments of the invention have been described, it is to be understood that modifications and changes will occur to those skilled in the art to which the invention pertains. For example, although acronyms are detected by identifying capital letters, other identification conventions may be utilized. Accordingly, the claims appended to this specification are intended to define the invention precisely.

1. A method of handling of acronyms in a speech recognition and text-to-speech system, the method comprising:
detecting an acronym from text;
identifying a language of the text based on non-acronym words in the text; and
utilizing the identified language in acronym pronunciation generation to generate a pronunciation for the detected acronym.

2. The method of claim 1, wherein the acronym is detected based on capital letters.

3. The method of claim 1, wherein utilize the identified language in acronym pronunciation generation to generate a pronunciation for the detected acronym comprises obtaining a phoneme sequence associated with the detected acronym.

4. The method of claim 3, further comprising constructing the detected acronym using acoustic models.

5. The method of claim 1, further comprising marking the detected acronym.

6. The method of claim 5, wherein marking comprises adding a < marker before the detected acronym and a > marker after the detected acronym.

7. The method of claim 1, wherein detecting an acronym from text comprises loading entries from a file.

8. A system for applying speech recognition and text-to-speech with acronyms, the system comprising:
a language identifier that identifies language of a text including a plurality of vocabulary items;
a vocabulary manager that separates the vocabulary items into single words and detects acronyms in the vocabulary items, and maintains the pronunciations of the words; and
a text-to-phoneme (TTP) module that generates pronunciations for the vocabulary items including pronunciations for acronyms and digit sequences.

9. The system of claim 8, wherein the language identifier, vocabulary manager, and TTP module are integrated into common computer software code.

10. The system of claim 8, wherein acronyms are detected using detection logic and marked to separate acronyms from non-acronyms.

11. The system of claim 10, wherein the detection logic identifies acronyms based on capital letters.

12. The system of claim 8, wherein the language identifier identifies language of the text from non-acronym words in the text.

13. The system of claim 8, wherein the text-to-phoneme (TTP) module generates pronunciations for the vocabulary items using language dependent alphabet tables.

14. A device that applies speech recognition and text-to-speech to acronyms, the device comprising:
a language identifier module that identifies a language of text and vocabulary items from the text;
a text to phoneme module that provides phoneme sequences for identified vocabulary items; and
a processor that executes instructions to construct text to speech signals using the phoneme sequences from the text to phoneme module based on the identified language of the text.

15. The device of claim 14, wherein the processor uses multilingual acoustic modeling in the construction of the text to speech signals.

16. The device of claim 14, wherein the language of the text is identified based on non-acronym vocabulary items from the text.

17. A computer program product comprising:
computer code to:
detect acronyms from text including acronyms and non-acronyms and mark the detected acronyms;
identify a language of the text based on non-acronym words; and
use the language in acronym pronunciation generation.

18. The computer program code of claim 17, wherein the detecting of acronyms is based on specific rules contained in memory.

19. The computer program code of claim 17, wherein an acronym pronunciation table is used for the generation of pronunciations.

20. The computer program product of claim 17, wherein the acronyms are marked using a < at a beginning of the acronym and a > at a end of the acronym.
